(19) United States
(12) Patent Application Publication
(10) Pub. No.: US 2019/0344469 A1
(43) Pub. Date: Nov. 14, 2019

(54) Reinforced Composites and Methods for Their Manufacture

(71) Applicant: Resolute FP Canada, Inc., Montreal (CA)

(72) Inventors: Shaune John Hanley, Montreal (CA); Otman Oulanti, Point-Claire (CA); Norayr Gurnagul, Pointe-Claire (CA); Danielle Gagné, Pointe-Claire (CA)

(21) Appl. No.: 16/407,333

(22) Filed: May 9, 2019

Related U.S. Application Data
(60) Provisional application No. 62/669,098, filed on May 9, 2018.
(60) Provisional application No. 62/738,096, filed on Sep. 28, 2018.

(51) Int. Cl. B27N 3/10; B27N 3/00; B29C 43/00; C08L 67/00

(52) U.S. Cl. CPC B27N 3/10; B27N 3/002; B29K 2067/00; C08L 67/00; B29C 43/003

(57) ABSTRACT

Disclosed herein are, for instance, reinforced composites comprising an airlaid mat comprising a natural fiber component; and a resin dispersed within the airlaid mat; wherein the reinforced composite has a natural fiber volume fraction of 20 vol % to 80 vol %, by volume of the reinforced composite. Also disclosed herein are methods of making reinforced composites. For instance, disclosed herein are methods comprising forming a preform comprising: heating an airlaid mat to a temperature of from 40° C. to 200° C., the airlaid mat comprising a natural fiber component and a binder fiber component; and compressing the airlaid mat at a pressure of from 100 psi to 1200 psi; and impregnating the preform with a resin to form a reinforced composite.

### CROSS-REFERENCE TO RELATED APPLICATIONS

This Application claims priority to U.S. Provisional Patent Application No. 62/669,098, filed 9 May 2018 and titled “Wood Pulp Fibre Air-laid Mat Reinforced Composites,” and U.S. Provisional Patent Application No. 62/738,096, filed 28 Sep. 2018 and titled “Reinforced Composites and Methods for Their Manufacture,” which are hereby incorporated by reference herein in their entireties as if fully set forth below.

### FIELD

The present disclosure relates generally to reinforced composites and methods of manufacturing the same. Particularly, embodiments of the present disclosure relate to reinforced composites manufactured from airlaid mats comprising natural fibers and optionally binder fibers.

### BACKGROUND

Reinforced composites include, for instance, composite materials comprising a resin matrix reinforced with fibers. The reinforced composites can be useful in a variety of fields including, but not limited to, construction/infrastructure, transportation, automotive, marine, anticorrosion, electronics, aerospace, building, medical, sport/recreation, lawn/garden products, energy, water desalination, and ground tanks. Generally, reinforced composites (including, for instance, thermoset and thermoplastic) can be formed using man-made fibers such as glass fibers as the reinforcement material to achieve mechanical performance. Prior attempts at creating airlaid wood pulp fiber reinforcement composites can be characterized by a low volume fraction (around 11%) and a low E′ (storage modulus), which can result in insufficient mechanical performance.

### BRIEF SUMMARY

Disclosed herein are, for instance, reinforced composites comprising an airlaid mat comprising a natural fiber component; and a resin dispersed within the airlaid mat; wherein the reinforced composite has a natural fiber volume fraction from 20 vol % to 80 vol %, by volume of the reinforced composite. In some embodiments, the airlaid mat further comprises a binder fiber component. In some embodiments, the airlaid mat comprises 1 wt % to 70 wt % of the binder fiber component, by weight of the airlaid mat; and from 30 wt % to 99 wt % of the natural fiber component, by weight of the airlaid mat. In some embodiments, the natural fiber component comprises at least one of a chemical pulp and a mechanical pulp. In some embodiments, the resin comprises an unsaturated polyester resin, an epoxy resin, a phenolic resin, a liquid thermoplastic resin, any thermoset resin, or a combination thereof. In some embodiments, the resin comprises a flame-retardant resin. In some embodiments, the natural fiber volume fraction is from 26 vol % to 55 vol %, by volume of the airlaid mat. In some embodiments, the binder fiber component is a bicomponent fiber, the bicomponent fiber comprising a core polymer and a sheath polymer. In some embodiments, the core polymer and the sheath polymer are each independently selected from the group consisting of a polyester, a polyethylene, a polypropylene, or any other suitable thermoplastic polymer. Also disclosed herein are reinforced composites comprising a fiber reinforcing material comprising 1 wt % to 70 wt % of a binder fiber component and 30 wt % to 99 wt % of a cellulose fiber component; and a matrix comprising a resin; wherein the reinforced composite has a cellulose fiber volume fraction of from 20 vol % to 75 vol %, by volume of the reinforced composite. In some embodiments, the reinforced composites further comprise a fire-retardant gel coat.

Also disclosed herein are methods of making reinforced composites. For instance, disclosed herein are methods comprising forming a preform comprising: heating an airlaid mat to a temperature of from 40° C. to 200° C., the airlaid mat comprising a natural fiber component and a binder fiber component; and compressing the airlaid mat at a pressure of from 100 psi to 1200 psi; and impregnating the preform with a resin to form a reinforced composite. In some embodiments, the reinforced composite comprises a natural fiber volume fraction of from 25 vol % to 65 vol %, by volume of the reinforced composite. In some embodiments, the method further comprises heating the airlaid mat for 1 minute or less before compressing the airlaid mat. In some embodiments, impregnating the preform with a resin further comprises molding the preform.

### BRIEF DESCRIPTION OF THE DRAWINGS

FIG. 1 illustrates a flow chart of a manufacturing process for making a reinforced composite, in accordance with some embodiments of the present disclosure.

FIG. 2a-2b show graphical representations illustrating the effects of pressing pressure on (2a) tensile strength and (2b) tensile modulus, in accordance with some embodiments of the present disclosure.

FIG. 3a-3b show graphical representations illustrating the effects of varying temperature and pressure on (3a) flexural strength and (3b) flexural modulus, in accordance with some embodiments of the present disclosure.

FIG. 4a-4b show graphical representations illustrating the effects of resin type on (4a) tensile strength and (4b) tensile modulus, in accordance with some embodiments of the present disclosure.

FIG. 5a-5b show a graphical representation comparing (5a) the tensile strength and (5b) flexural strength of reinforced composites wherein the process for making the reinforced composites was varied.

### DETAILED DESCRIPTION

Although some embodiments of the disclosure are explained in detail, it is to be understood that other embodiments are contemplated. Accordingly, it is not intended that the disclosure is limited in its scope to the details of construction and arrangement of components set forth in the following description or illustrated in the drawings. The disclosure is capable of other embodiments and of being practiced or carried out in various ways.

It must also be noted that, as used in the specification and the appended claims, the singular forms “a,” “an” and “the” include plural referents unless the context clearly dictates otherwise.

Also, in describing the embodiments, terminology will be resorted to for the sake of clarity. It is intended that each term contemplates its broadest meaning as understood by those skilled in the art and includes all technical equivalents that operate in a similar manner to accomplish a similar purpose.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Wood pulp fibers are natural fibers that are highly absorbent and have traditionally been used in absorbent materials such as diapers and feminine hygiene products. However, due to their porous structure and high absorbency, wood pulp fibers have not traditionally been an attractive alternative to man-made fibers, such as glass fibers in reinforced composites, particularly those for use in more robust environments where flame retardance and mechanical properties are of particular concern. This is because wood pulp fibers were thought to be unable to provide the appropriate mechanical reinforcement of traditional reinforced composites, were highly flammable, and would absorb too much resin resulting in poor composite reinforcement with very low fiber loading in the final composite. Indeed, the only attempts at fabricating composites from wood pulp fiber airlaid mats contained resin content around 83% by weight with a very low fiber volume fraction (of about 11% by volume) and were characterized by low E′ (storage modulus), which resulted in poor composite performance.

Some embodiments of the present disclosure include reinforced composites that can comprise natural fibers and can be characterized by a high fiber volume fraction. The inventors discovered, among other things, that airlaid mat resin absorbency can be controlled by compressing the fiber preform before resin impregnation. This means that the resin amount in the reinforced composite can be controlled by compressing the airlaid mat before resin impregnation. In some embodiments, the reinforced composites can comprise a compressed airlaid mat that can comprise a natural fiber component and a binder fiber component (e.g., monocomponent or bicomponent fibers). In some embodiments, the airlaid mat can be impregnated with a resin to form a reinforced composite including a matrix formed from the resin and at least a portion of the binder fiber component and reinforced with the natural fiber component, present at a high fiber volume fraction.

As used herein, “reinforced composite” can relate to a composite material comprising a matrix reinforced with a reinforcing fiber material. In some embodiments, the reinforced composite can comprise a resin matrix reinforced with a natural fiber component. In some embodiments, the natural fiber component can include a binder fiber component.

In some embodiments, the binder fiber component can comprise a bicomponent fiber. A bicomponent fiber can include a fiber formed from two varieties of a single polymer type and can structurally comprise a core polymer and a sheath polymer. Because the core and sheath polymers can be varieties of the same polymer, they can retain their polymeric identity but have different melting points, which can render the bicomponent fibers useful as bonding agents. A person of ordinary skill in the art would recognize that a variety of core/sheath arrangements could be used. A person of ordinary skill in the art would recognize that the melting point of the sheath polymer varies depending on the composition of the sheath polymer, and that the bicomponent fibers can be heated in some embodiments to a temperature sufficient for bonding (e.g., above the melting point of the sheath polymer but below the melting temperature of the core polymer). As discussed in more detail below, the airlaid mats can be compressed at a certain temperature. In some embodiments, the particular temperature can depend on the melting temperature of the binder fiber component of the airlaid mat.

In some embodiments, the core of the bicomponent fiber can comprise one or more of polyester (which can have a melting temperature of from about 250° C. to about 280° C.), the sheath of the bicomponent fiber can be a polyethylene (which can have a melting temperature of from about 100° C. to about 115° C. for low-density polyethylene and from about 115° C. to about 180° C. for medium- to high-density polyethylene) and/or polypropylene (which can have a melting temperature of from about 130° C. to about 170° C.). In some embodiments, the bicomponent fibers can comprise a core polymer and a sheath polymer. In some embodiments, the core polymer can comprise one or more of a polyester, a polyethylene, and/or a polypropylene. In some embodiments, the core polymer can be selected from the group consisting of a polyester, a polyethylene, a polypropylene, a polyethylene terephthalate, and a polybutylene terephthalate. In some embodiments, the sheath polymer can comprise one or more of a polyester, a polyethylene, and/or a polypropylene. In some embodiments, the sheath polymer can be selected from the group consisting of a polyester, a polyethylene, and a polypropylene. In some embodiments, the bicomponent fiber can comprise a polyester core and a polycaprolactone or polylactic acid sheath. In some embodiments, the bicomponent fiber can comprise a polyester core and a polyethylene sheath. In some embodiments, the bicomponent fiber can comprise a polypropylene core and a polyethylene sheath. In some embodiments, the bicomponent fiber can comprise a polyethylene terephthalate core and a polyethylene sheath. In some embodiments, the bicomponent fiber can be composed of a core polymer having a higher melting temperature than the sheath polymer. A person of ordinary skill in the art would recognize that any suitable bicomponent fiber, monocomponent fiber, or combination thereof would work in the embodiments disclosed herein and can include any thermoplastic polymer (or combinations of thermoplastic polymers) can be used. In some embodiments, the binder fibers include polylactic acid (PLA), polyhydroxyalkanoates (PHA), and/or other biodegradable polymers.

In some embodiments, the binder fiber component can be a monocomponent fiber composed of one or more of the polymers described above. In other embodiments, the binder fiber material can be a multi-component fiber comprising more than two polymer components.

In some embodiments, the reinforcing fiber material of the airlaid mat can comprise a natural fiber component. In some embodiments, the natural fiber component can comprise wood-based fibrous materials or non-wood-based fibrous materials. Wood-based fibrous materials can include cellulose and include mechanical pulps, chemical pulps, thermo-mechanical pulps, or chemi-mechanical pulps. In some embodiments, the pulp can be chosen from the group consisting of a southern bleached softwood Kraft pulp, a northern bleached softwood Kraft pulp, or unbleached pulp. In some embodiments, the pulp can be curled pulp prepared by one or both of a chemical or mechanical curling process. In some embodiments, the fibers can be curled using a process as described in U.S. Application Publication No. 2016/0289895A1. In some embodiments, the non-wood-based fibrous materials can include cotton, hemp, flax, etc.

In some embodiments, the compressed fiber preform can comprise a mat formed by the airlaid process, as discussed in more detail below. As used herein, “airlaid” can refer to a preform formed by a process comprising generally fiber defibration, web formation, and web bonding. In some embodiments, selection of the type of natural fiber may depend on the type of machinery used in the airlaid process. For instance, in embodiments where a drum former is used to form the airlaid mat, any length fiber can be used (e.g., fibers having a length of 1 mm, 2 mm, 3 mm, 4 mm, 5 mm, 6 mm, 7 mm, 8 mm, 9 mm, 10 mm, 11 mm, 12 mm, greater than 12 mm, from 1 mm to 12 mm or from 6 mm to 12 mm). Or, for instance, in embodiments where a spike former is used to form the airlaid mat, generally the fiber length should be less than or equal to approximately 12 mm.

In other embodiments, the compressed fiber preform can comprise a mat formed by a carding process.

In some embodiments, the natural fiber component can include a modified natural fiber, such as a natural fiber modified for use with a corresponding resin.

In some embodiments, the airlaid mat can comprise from about 30 to about 99 percent by weight (e.g., “wt %”) of natural fibers and from about 1 wt % to about 70 wt % binder fibers, by weight of the airlaid mat. In some embodiments, the airlaid mat can comprise at least 30 wt % natural fibers, at least 35 wt % natural fibers, at least 40 wt % natural fibers, at least 45 wt % natural fibers, at least 50 wt % natural fibers, at least 55 wt % natural fibers, at least 60 wt % natural fibers, at least 65 wt % natural fibers, at least 70 wt % natural fibers, at least 75 wt % natural fibers, at least 80 wt % natural fibers, at least 85 wt % natural fibers, at least 90 wt % natural fibers, at least 95 wt % natural fibers, or 99 wt % natural fibers, by weight of the airlaid mat. In some embodiments, the airlaid mat can comprise 30 wt % to 35 wt % natural fibers, 36 wt % to 40 wt % natural fibers, 41 wt % to 45 wt % natural fibers, 46 wt % to 50 wt % natural fibers, 51 wt % to 55 wt % natural fibers, 56 wt % to 60 wt % natural fibers, 61 wt % to 65 wt % natural fibers, 66 wt % to 70 wt % natural fibers, 71 wt % to 75 wt % natural fibers, 76 wt % to 80 wt % natural fibers, 81 wt % to 85 wt % natural fibers, 86 wt % to 90 wt % natural fibers, 91 wt % to 95 wt % natural fibers, or 96 wt % to 99 wt % natural fibers, by weight of the airlaid mat. In some embodiments, the airlaid mat can comprise about 30 wt % natural fibers, about 40 wt % natural fibers, about 50 wt % natural fibers, about 60 wt % natural fibers, about 70 wt % natural fibers, about 72 wt % natural fibers, about 73 wt % natural fibers, about 75 wt % natural fibers, about 78 wt % natural fibers, about 80 wt % natural fibers, about 82 wt % natural fibers, about 83 wt % natural fibers, about 85 wt % natural fibers, about 87 wt % natural fibers, about 90 wt % natural fibers, about 93 wt % natural fibers, about 95 wt % natural fibers, about 97 wt % natural fibers, or about 99 wt % natural fibers, by weight of the airlaid mat.

In some embodiments, the airlaid mat can comprise at most 70 wt % binder fibers, at most 65 wt % binder fibers, at most 60 wt % binder fibers, at most 55 wt % binder fibers, at most 50 wt % binder fibers, at most 45 wt % binder fibers, at most 40 wt % binder fibers, at most 35 wt % binder fibers, at most 30 wt % binder fibers, at most 25 wt % binder fibers, at most 20 wt % binder fibers, at most 15 wt % binder fibers, at most 10 wt % binder fibers, at most 5 wt % binder fibers, or at most 1 wt % binder fibers, by weight of the airlaid mat. In some embodiments, the airlaid mat can comprise 1 wt % to 5 wt % binder fibers, 6 wt % to 10 wt % binder fibers, 11 wt % to 15 wt % binder fibers, 16 wt % to 20 wt % binder fibers, 21 wt % to 25 wt % binder fibers, 26 wt % to 30 wt % binder fibers, 31 wt % to 35 wt % binder fibers, 36 wt % to 40 wt % binder fibers, 41 wt % to 45 wt % binder fibers, 46 wt % to 50 wt % binder fibers, 51 wt % to 55 wt % binder fibers, 56 wt % to 60 wt % binder fibers, 61 wt % to 65 wt % binder fibers, or 66 wt % to 70 wt % binder fibers, by weight of the airlaid mat. In some embodiments, the airlaid mat can comprise about 1 wt % binder fibers, 3 wt % binder fibers, 5 wt % binder fibers, about 6 wt % binder fibers, about 8 wt % binder fibers, about 10 wt % binder fibers, about 12 wt % binder fibers, about 15 wt % binder fibers, about 18 wt % binder fibers, about 20 wt % binder fibers, about 25 wt % binder fibers, about 30 wt % binder fibers, about 35 wt % binder fibers, about 40 wt % binder fibers, about 45 wt % binder fibers, about 50 wt % binder fibers, about 55 wt % binder fibers, about 60 wt % binder fibers, about 65 wt % binder fibers, or about 70 wt % binder fibers, by weight of the airlaid mat.

In some embodiments, the reinforced composites can comprise a resin. The reinforced composites can comprise a variety of resins or a mixture of a variety of resins. In some embodiments, the reinforced composites can comprise a fire-retardant resin. In some embodiments, the reinforced composites can comprise an unsaturated (reactive) polyester resin. Such resins can comprise mixtures of polyesters or polycondensation products of dicarboxylic acids with dehydroxy alcohols and a compatible copolymerizable ethylenically unsaturated monomer. Generally, the polyester component can be dissolved in any of the known solvents for dissolving polyester (e.g., styrene). These two components can react or copolymerize in the presence of a free radical catalyst such as a peroxide to form a rigid, infusible thermoset resin. Representative of the dicarboxylic acids are the unsaturated dibasic acids such as fumaric acid, maleic acid, maleic anhydride, and the like; and saturated dibasic acids such as phthalic anhydride, isophthalic acid, adipic acid, orthophthalic acid, and the like. Suitable glycols include ethyleric glycol, diethylene glycol, propylene glycol, and the like. Among the copolymerizable monomers are styrene, diallyl phthalate, methyl methacrylate, and the like.

The peroxides useful for catalyzing the polyester reaction system and to initiate the copolymerization reaction are organic peroxides which decompose to release free radicals. Among the most commonly used peroxides are methylethyl ketone peroxide, benzoyl peroxide, and cumene hydroperoxide. Other suitable peroxides are 2, 4-dichlorobenzoyl peroxide, and cyclohexonone peroxide, and the like. These peroxides can be used along or in conjunction with accelerators such as cobalt octoate, cobalt napthenate or dimethyl amine or the like.

In some embodiments, the polyester resin can be a low viscosity polyester resin. Polyesters with a low viscosity can be those having a viscosity of from 300 centipoises to 700 centipoises when measured at a temperature of from 30° C. to 40° C. In some embodiments, the viscosity can be about 300 centipoises, about 350 centipoises, about 400 centipoises, about 450 centipoises, about 500 centipoises, about 550 centipoises, about 600 centipoises, about 650 centipoises, or about 700 centipoises. In some embodiments, the viscosity can be from 300 centipoises to 400 centipoises, from 400 centipoises to 500 centipoises, from 500 centipoises to 600 centipoises, or 600 centipoises to 700 centipoises. Those of skill in the relevant art would understand that viscosity of a resin can be measured according to ASTM D445-17a (2017).

It will be appreciated, however, that any resins can be used so long as they can be processed by infusion or resin transfer molding (RTM) process for imparting a resin to a preform. These resins can include liquid thermoplastic resins such as acrylic resin or polyolefins such as polyethylene or polypropylene and/or thermosetting resins such as epoxides, melamine, phenolics, polyimides, silicone, diallyl-phthalate resins, and bio-based resins can be used with appropriate catalyst systems. Also, a single resin or a mixture of these resins can be employed. Suitable solvents and plasticizers can be added to this resin when required.

In some embodiments, the reinforced composites can comprise from 20 wt % to 70 wt % resin, based on the weight of the reinforced composite, depending on the percentage of binder fiber and natural fiber in the preform. In some embodiments, the reinforced composite can comprise 20 wt % resin, 25 wt % resin, 30 wt % resin, 35 wt % resin, 40 wt % resin, 45 wt % resin, 50 wt % resin, 55 wt % resin, 60 wt % resin, 65 wt % resin or 70 wt % resin, based on the weight of the reinforced composite. In some embodiments, the reinforced composite can comprise from 20 wt % resin to 25 wt % resin, 26 wt % resin to 30 wt % resin, 31 wt % resin to 35 wt % resin, 36 wt % resin to 40 wt % resin, 41 wt % resin to 45 wt % resin, 46 wt % resin to 50 wt % resin, 51 wt % resin to 55 wt % resin, 56 wt % resin to 60 wt % resin, 61 wt % resin to 65 wt % resin, 66 wt % resin to 70 wt % resin, based on the weight of the reinforced composite.

In some embodiments, the reinforced composites can comprise additional additives. In some embodiments, the additional additives can be chosen from fiber treatment materials (e.g., phosphorylated wood pulp fibers) or fillers (e.g., aluminum tri-hydrate (ATH) for fire retardance or calcium carbonate).

The reinforced composites can have a high fiber volume fraction of natural fibers. In general, the term “fiber volume fraction” refers to the volume of the fiber divided by the volume of the entire constituent. The fiber volume fraction is typically calculated based on measurements of volume and density according to standards used in the industry. The fiber volume fraction for a composite made from fiber and matrix, Vf, can be determined by Equation 1 below:

$$Vf = \frac{Wf / ρ f}{\frac{Wf}{ρ f} + ( 1 - Wf ) / ρ m} * 100 \qquad ( 1 )$$

where Vf=volume fiber fraction, Wf=weight fiber fraction, pf=fibre density, Vm=Volume matrix fraction Wf=Weight matrix fraction, and μm=matrix density.

In some embodiments, the reinforced composites can comprise a natural fiber volume content of 20% or more, by volume of the reinforced composite. In some embodiments, the natural fiber volume content of the reinforced composites can be from 30% to 70%, by volume of the reinforced composite. For instance, the natural fiber volume content of the reinforced composites can be about 50%, about 55%, about 60%, about 65%, or about 70%, by volume of the reinforced composite. In some embodiments, the natural fiber volume content of the reinforced composites can be from 50% to 70%, 50% to 65%, 50% to 55%, 51% to 54%, 55% to 60%, 60% to 65%, less than 70%, less than 65%, less than 60%, or less than 55%, by volume of the reinforced composite.

Some advantages of the presently disclosed reinforced composites is that they can achieve desired mechanical performance and flame retardance. In some embodiments, the reinforced composites can have a flexural modulus of at least about 4 GPa, a tensile modulus of at least about 3 GPa, a tensile strength of at least about 40 MPa, and a flexural strength of at least about 70 MPa. Additionally, reinforced composites formed from a compressed mat before resin-impregnation can have a density of about 1.3 g/cc which are indeed less dense than composites made with glass fiber or other inorganic fibers, and require less resin, making the presently described composites cheaper to manufacture and lighter (and therefore more environmentally efficient).

In some embodiments, the reinforced composite can have multiple layers of airlaid mats laminated together. For instance, in some embodiments the reinforced composite can comprise 1 layer, 2 layers, 3 layers, 4 layers, 5 layers, or 6 layers. It is understood that, depending on the use, the number of layers can exceed 6 layers. In some embodiments, the layers can be laminated together during the compression process.

In some embodiments, the airlaid mats can have a weight of from 700 gsm (grams per square meter) to 4000 gsm. For instance, the airlaid mats can have a weight of 700 gsm, 800 gsm, 900 gsm, 1000 gsm, 1500 gsm, 2000 gsm, 2500 gsm, or 3000 gsm. For instance, the airlaid mats can have a weight of from 700 gsm to 800 gsm, 800 gsm to 900 gsm, 900 gsm to 1000 gsm, 1000 gsm to 1500 gsm, 1500 gsm to 2000 gsm, 2000 gsm to 2500 gsm, 3000 gsm to 3500 gsm, or 3500 gsm to 4000 gsm. A person of ordinary skill in the art would recognize that the weight of the airlaid mat can be expanded above or below the ranges (above in this paragraph) as needed for various other applications and uses.

In some embodiments, to improve the fire-retardant properties of the reinforced composites, the reinforced composites can be coated with a fire-retardant gel coat and/or impregnated with a resin or other flame-retardant material. As used herein, “fire retardant” and “flame retardant” can refer to a substance that is used to slow or stop the spread of fire or reduce its intensity. In some embodiments, the reinforced composites are fire retardant.

Embodiments of the present disclosure can include a process for manufacturing a reinforced composite. The process can include the steps of compressing an airlaid mat to form a preform and impregnating the airlaid mat with a resin to form the reinforced composite.

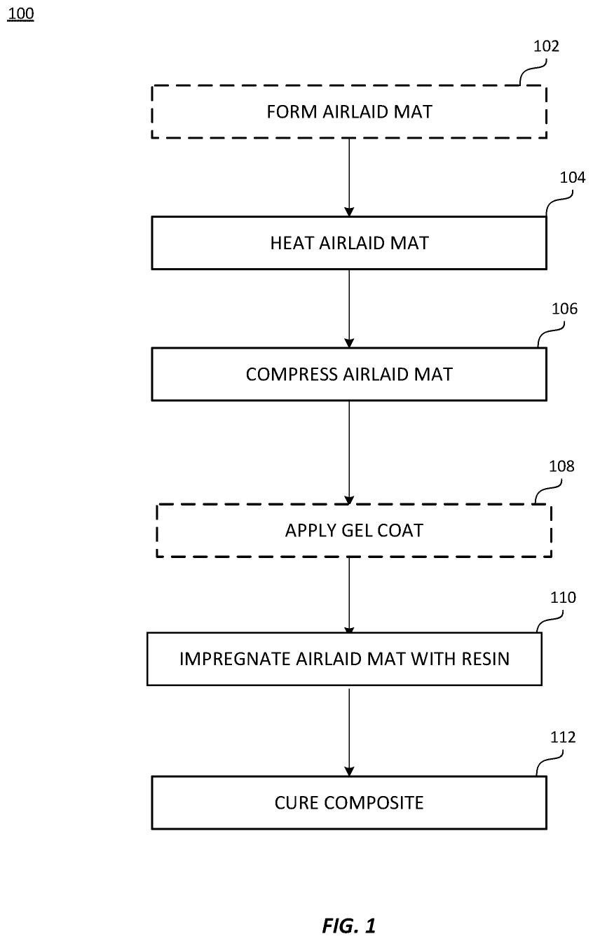

FIG. 1 illustrates a flow chart of a manufacturing process for making a reinforced composite, in accordance with some embodiments of the present disclosure. The process steps can be represented graphically as a series of steps conducted with an airlaid mat. A person of ordinary skill in the art would understand that the airlaid mat of the process steps can have some or all of the features discussed with respect to the above-described airlaid mats. In FIG. 1, an airlaid mat can be formed at 102. The airlaid mat can be formed using any device known in the art that can form airlaid mats. Those skilled in the art would understand that an airlaid mat can be formed by a device generally including a fiber feed for providing the natural fibers, a refiner (e.g., a defibrator), a forming head receiving the defibrated natural fibers and binder fibers to form a web, and a conveyor on which the web is compacted.

After forming the airlaid mat, the airlaid mat can be heated at step 104 to a temperature. In some embodiments, the heating can be performed in a hot press, an infrared system, or an oven and the temperature chosen may be sufficient to soften the mat. In some embodiments, the temperature can be chosen based on a melting temperature of the binder fibers. In embodiments where the binder fibers are bicomponent fibers, the temperature can be chosen based on the melting temperature of the sheath of the bicomponent fiber, for instance, as discussed above. In other embodiments, the airlaid mat can be heated in the mold or heated in an oven or an infrared system and then transferred to the mold.

In some embodiments, the temperature can be from 40 degrees Celsius to 200 degrees Celsius. In some embodiments, the temperature can be from about 40 degrees Celsius to about 50 degrees Celsius, from about 50 degrees Celsius to about 100 degrees Celsius, from about 140 degrees Celsius to about 200 degrees Celsius, or from about 150 degrees Celsius to about 175 degrees Celsius. In some embodiments, the temperature can be at least 40 degrees Celsius, at least 50 degrees Celsius, at least 60 degrees Celsius, at least 70 degrees Celsius, at least 75 degrees Celsius, at least 80 degrees Celsius, at least 90 degrees Celsius, at least 100 degrees Celsius, at least 110 degrees Celsius, at least 120 degrees Celsius, at least 130 degrees Celsius, at least 140 degrees Celsius, at least 150 degrees Celsius, at least 160 degrees Celsius, at least 170 degrees Celsius, at least 180 degrees Celsius, at least 190 degrees Celsius, or at least 200 degrees Celsius. In some embodiments the temperature can be about 40 degrees Celsius, about 45 degrees Celsius, about 50 degrees Celsius, about 60 degrees Celsius, about 70 degrees Celsius, about 75 degrees Celsius, about 80 degrees Celsius, about 90 degrees Celsius, about 100 degrees Celsius, about 120 degrees Celsius, about 125 degrees Celsius, about 130 degrees Celsius, about 140 degrees Celsius, about 150 degrees Celsius, about 160 degrees Celsius, about 165 degrees Celsius, about 170 degrees Celsius, about 175 degrees Celsius, about 180 degrees Celsius, about 185 degrees Celsius, about 190 degrees Celsius, about 195 degrees Celsius, or about 200 degrees Celsius.

In some embodiments, the airlaid mat can be heated for a period of time. For instance, in some embodiments, the airlaid mat can be heated for about 20 minutes or less, about 10 minutes or less, about 5 minutes or less, or about 1 minute or less. In some embodiments, the airlaid mat can be heated for between about 1 minute and about 4 minutes, between about 5 minutes and about 9 minutes, or between about 10 minutes and about 15 minutes.

At step 106, the heated airlaid mat can be compressed. In some embodiments, the compressing can be done using a hot and cooling press. In some embodiments, the compressing can be performed using a compression mold at a temperature lower than a softening temperature of the airlaid mat or the binder fiber temperature. In some embodiments, the airlaid mat can be compressed at a pressure of from about 100 psi to about 1200 psi. In some embodiments, the pressure of the compression can be from about 100 psi to about 110 psi, from about 110 psi to about 120 psi, from about 120 psi to about 150 psi, from about 100 psi to about 200 psi, about 130 psi to about 140 psi, from about 200 psi to about 300 psi, from about 300 psi to about 400 psi, from about 400 psi to about 500 psi, from about 500 psi to about 600 psi, from about 600 psi to about 700 psi, from about 700 psi to about 800 psi, from about 800 psi to about 900 psi, from about 900 psi to about 1000 psi, or from about 1000 psi to about 1200 psi. In some embodiments, the airlaid mat can be compressed at a pressure of from about 100 psi to about 500 psi, from about 600 psi to about 1000 psi, or from about 1100 psi to about 1200 psi.

In some embodiments, the airlaid mat can be compressed for a period of time. For instance, in some embodiments, the airlaid mat can be compressed for about 20 minutes or less, about 10 minutes or less, about 5 minutes or less, or about 1 minute or less. In some embodiments, the airlaid mat can be compressed for between about 1 minute and about 4 minutes, between about 5 minutes and about 9 minutes, or between about 10 minutes and about 15 minutes. In some embodiments, the airlaid mat can be cooled after it is compressed. In some embodiments, the airlaid mat is cooled while it is being compressed. In some embodiments, the airlaid mat undergoes additional processing before it is cooled. In some embodiments, the airlaid mat is cooled to a temperature of 45° C. or less (e.g., 40° C. or less, 38° C. or less, 36° C. or less, 34° C. or less, 32° C. or less, 30° C. or less, 28° C. or less, 26° C. or less, or 24° C. or less).

At step 110, the compressed airlaid mat can be impregnated with a resin. In some embodiments, the compressed airlaid mat can be impregnated with a resin as part of a molding process. In some embodiments, the reinforced composite can be formed using vacuum-assisted resin transfer molding (VRTM). As used herein, VRTM can refer to a resin transfer molding process in which a vacuum is used and can involve more specifically replacing the upper half of a conventional mold with a vacuum bag. In some embodiments, the molding process can be resin transfer molding (RTM) wherein the airlaid mat preform is draped within a mold having a desired shape corresponding to the desired shape of the final reinforced composite and injected with a liquid resin while the mold is closed and cured. In some embodiments, the compressed airlaid mat can be impregnated with a resin as part of an infusion process.

At step 112, the reinforced composite can be cured to set the resin.

In some embodiments, before airlaid mat impregnation with a resin 110, at step 108 a fire-retardant gel coat can be applied to the mold prior to incorporation of the compressed airlaid mat to the mold. In some embodiment, a gel coat can be applied by a drawdown process. In other embodiments, the gel coat may be applied by spraying the gel coat on the mold before molding the reinforced composite.

In some embodiments, the airlaid mats used as reinforcement in the composites disclosed herein are prepared using two or more (e.g., 3 or more, 4 or more, 5 or more, 6 or more) temperature and/or pressure cycles. In some embodiments, the reinforced composites are prepared by heating an airlaid mat to a first temperature and then compressing the airlaid mat at a first pressure for a first amount of time, the mat was then cooled under similar pressure to a temperature of 40-45° C., followed by heating the airlaid mat to a second temperature and then compressing the airlaid mat to a second pressure for a second amount of time, the mat was then cooled under similar pressure to a temperature of 40-45° C., followed by impregnating the airlaid mat obtained from the second cycle of temperature/pressure with a resin to form a reinforced composite. In some embodiments, the first temperature and/or second temperature can be from 40 degrees Celsius to 200 degrees Celsius. In some embodiments, the first and/or second temperature can be from about 40 degrees Celsius to about 50 degrees Celsius, from about 50 degrees Celsius to about 100 degrees Celsius, from about 140 degrees Celsius to about 200 degrees Celsius, or from about 150 degrees Celsius to about 175 degrees Celsius. In some embodiments, the first and/or second temperature can be at least 40 degrees Celsius, at least 50 degrees Celsius, at least 60 degrees Celsius, at least 70 degrees Celsius, at least 75 degrees Celsius, at least 80 degrees Celsius, at least 90 degrees Celsius, at least 100 degrees Celsius, at least 110 degrees Celsius, at least 120 degrees Celsius, at least 130 degrees Celsius, at least 140 degrees Celsius, at least 150 degrees Celsius, at least 160 degrees Celsius, at least 170 degrees Celsius, at least 180 degrees Celsius, at least 190 degrees Celsius, or at least 200 degrees Celsius. In some embodiments, the first and/or second temperature can be about 40 degrees Celsius, about 45 degrees Celsius, about 50 degrees Celsius, about 60 degrees Celsius, about 70 degrees Celsius, about 75 degrees Celsius, about 80 degrees Celsius, about 90 degrees Celsius, about 100 degrees Celsius, about 120 degrees Celsius, about 125 degrees Celsius, about 130 degrees Celsius, about 140 degrees Celsius, about 150 degrees Celsius, about 160 degrees Celsius, about 165 degrees Celsius, about 170 degrees Celsius, about 175 degrees Celsius, about 180 degrees Celsius, about 185 degrees Celsius, about 190 degrees Celsius, about 195 degrees Celsius, or about 200 degrees Celsius.

In some embodiments, the first and/or second pressure can be from about 100 psi to about 1200 psi. In some embodiments, the first and/or second pressure can be from about 100 psi to about 110 psi, from about 110 psi to about 120 psi, from about 120 psi to about 150 psi, from about 100 psi to about 200 psi, about 130 psi to about 140 psi, from about 200 psi to about 300 psi, from about 300 psi to about 400 psi, from about 400 psi to about 500 psi, from about 500 psi to about 600 psi, from about 600 psi to about 700 psi, from about 700 psi to about 800 psi, from about 800 psi to about 900 psi, from about 900 psi to about 1000 psi, or from about 1000 psi to about 1200 psi. In some embodiments, the first and/or second pressure can be from about 100 psi to about 500 psi, from about 600 psi to about 1000 psi, or from about 1100 psi to about 1200 psi. In some embodiments, the second pressure is lower than the first pressure. In some embodiments, the first pressure is from about 100 psi to about 1200 psi (examples given above) and the second pressure can be from about 0 psi to about 50 psi, from about 50 to 100 psi, from about 100 psi to about 120 psi, from about 120 psi to about 150 psi, from about 100 psi to about 200 psi, about 130 psi to about 140 psi, or from about 200 psi to about 300 psi. In some embodiments, the second pressure is at least 200 psi (e.g., at least 225 psi, at least 250 psi, at least 275 psi, at least 300 psi, at least 325 psi, at least 350 psi, at least 375 psi, at least 400 psi, at least 425 psi, at least 450 psi, at least 475 psi, at least 500 psi, at least 525 psi, at least 550 psi, at least 575 psi, at least 600 psi, at least 625 psi, at least 650 psi, at least 675 psi, at least 700 psi, at least 725 psi, at least 750 psi, at least 775 psi, at least 800 psi, at least 825 psi, at least 850 psi, at least 875 psi, at least 900 psi, at least 925 psi, at least 950 psi, at least 975 psi, at least 1000 psi, at least 1025 psi, at least 1050 psi, at least 1075 psi, at least 1100 psi, at least 1125 psi, at least 1150 psi, at least 1175 psi, at least 1200 psi) less than the first pressure. In some embodiments, the first and/or second amount of time can be about 20 minutes or less, about 10 minutes or less, about 5 minutes or less, or about 1 minute or less. In some embodiments, the first and/or second amount of time can be from about 1 minute to about 4 minutes, from about 5 minutes to about 9 minutes, or from about 10 minutes to about 15 minutes.

In some embodiments, equivalent mechanical properties of the reinforced composites can be achieved using airlaid mats prepared by one cycle or more than one temperature/pressure cycle. In some embodiments, improved mechanical properties of the reinforced composites can be achieved using airlaid mats prepared by more than one cycle, compared to using one temperature/pressure cycle. In some embodiments, the airlaid mat reinforcing the composite is molded/shaped to the desired shape in the final temperature/pressure cycle of the multi-cycle method.

The following examples are provided by way of illustration but not by way of limitation.

### EXAMPLES

### Example 1

### Methods

Wood pulp fiber (SBSK pulp) and bicomponent fibers (TREVIRA, 6 mm, 1.3 dtex, PET core and PE sheath) were obtained and used to form an airlaid mat using conventional airlaid processes. Airlaid mat preforms made of 95 wt % wood pulp fiber and 5 wt % bicomponent fiber were heated at a temperature of 165° C. for 10 minutes. The mats were then compressed to the desired pressure and held at that pressure and temperature (165° C.) for 10 minutes. The mats were then cooled under similar pressure to a temperature of 40-45° C. The airlaid mat preforms were impregnated with a polyester resin (POLYNT RL-2710) using an infusion process.

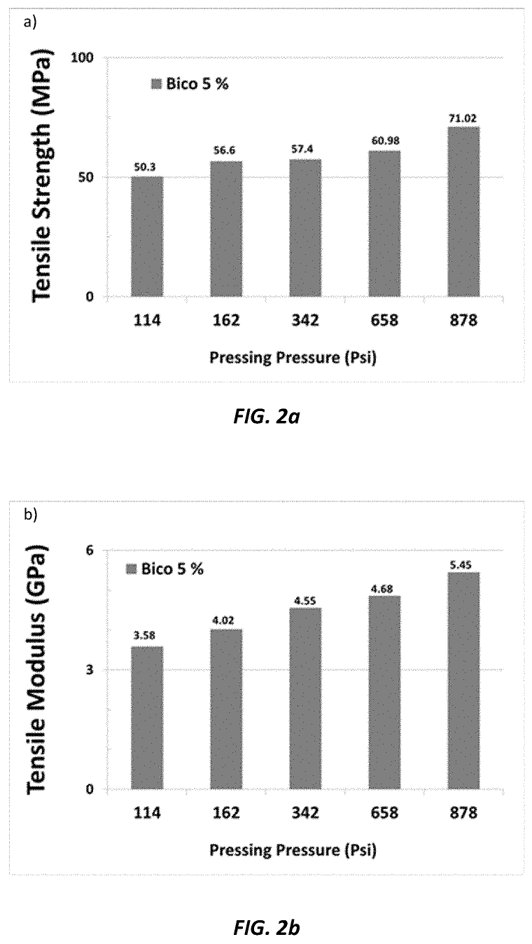

Tensile strength and tensile modulus measurements were acquired for each composite, as shown in FIG. 2a-2b. Tensile strength was measured according to ASTM D638-14 (2014) and tensile modulus was measured according to ASTM D638-14 (2014) as shown in Table 1 below.

### Results

FIG. 2a-2b shows a graphical representation comparing the (2a) tensile strength and (2b) tensile modulus of reinforced composites wherein the pressure during compression was varied.

TABLE 1

| | Pressure | Tensile Strength | Tensile Modulus |
|---|---|---|---|
| Composite | (psi) | (MPa) | (GPa) |
| A | 114 | 50.3 | 3.58 |
| B | 162 | 56.6 | 4.02 |
| C | 342 | 57.4 | 4.55 |
| D | 658 | 60.98 | 4.68 |
| E | 878 | 71.02 | 5.45 |

As illustrated above, the airlaid mat preform compression pressures has an important impact on the mechanical properties of the resulting reinforced composite. The pressure increase is proportional to the wood pulp fiber loading and volume fraction on the final composite. The composites exhibited a wood pulp fiber volume fraction of from 26 to 54% and wood pulp fiber loading by weight of from 31 to 60%. Additionally, as illustrated above, composites A, B, C, D, and E can exhibit a tensile strength and a tensile modulus exceeding the required tensile strength and modulus for mass transit, car interior and/or building applications.

### Example 2

### Methods

Wood pulp fiber (SBSK pulp) and bicomponent fibers (TREVIRA, 6 mm, 1.3 dtex, PET core and PE sheath) were obtained and used to form an airlaid mat using conventional airlaid processes. Two airlaid mat preforms made of 80 wt % wood pulp fiber and 20 wt % bicomponent fiber were heated at a temperature of 165° C. and 200° C. for 10 minutes respectively and compressed at a pressure of 878 psi and 1200 psi respectively for 10 minutes. The two airlaid mat preforms were then cooled under similar pressures respectively to a temperature of 40-45° C. The airlaid mat preforms were impregnated with a polyester resin (POLYNT RL-2710) using an infusion process.

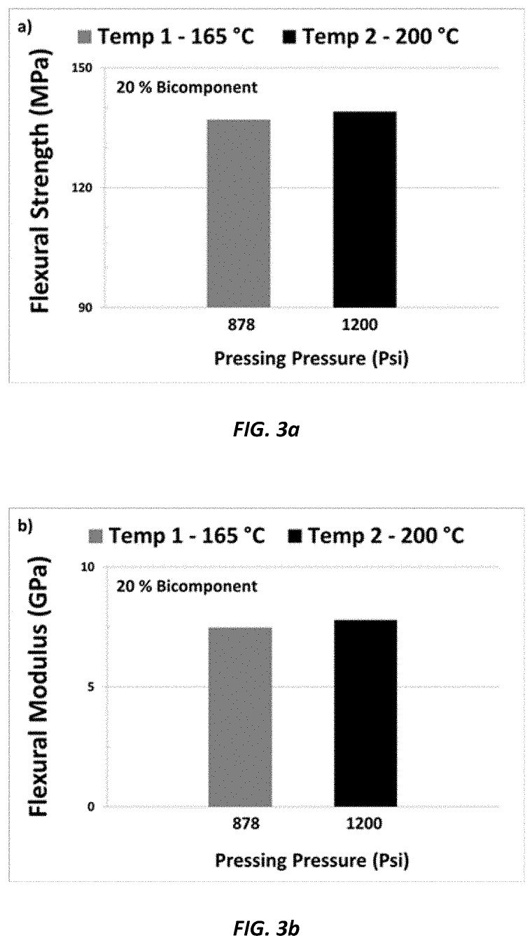

Flexural strength and flexural modulus measurements were acquired for each composite, as shown in FIG. 3a-3b. Flexural strength was measured according to ASTM D790-17 (2017) and flexural modulus was measured according to ASTM D790-17 (2017), as shown in Table 2 below.

### Results

FIG. 3a-3b show a graphical representation comparing (3a) the flexural strength and (3b) flexural modulus of reinforced composites wherein the temperature and pressure during airlaid mats compression was varied.

TABLE 2

| | Pressure | | |
|---|---|---|---|
| | (psi)/ | | |
| | Temperature | Flexural Strength | Flexural Modulus |
| Composite | (° C.) | (MPa) | (GPa) |
| F | 878/165 | 137.0 | 7.46 |
| G | 1200/200 | 139.1 | 7.79 |

As illustrated above, composites F and G can exhibit a flexural strength and/or flexural modulus exceeding the required flexural strength and flexural modulus for mass transit, car interior and/or building applications. Additionally, FIG. 3a-3b illustrate the impact of compression pressure and temperature on the mechanical properties of the resulting reinforced composite. Similar reinforced composite performances can be achieved at various airlaid mat preforms compression pressures and temperatures. The composites exhibited a wood pulp fiber volume fraction of about 54%.

### Example 3

### Methods

Wood pulp fiber (SBSK pulp) and bicomponent fibers (TREVIRA, 6 mm, 1.3 dtex, PET core and PE sheath) were obtained and used to form an airlaid mat using conventional airlaid processes. Airlaid mat preforms made of 95 wt % wood pulp fiber and 5 wt % bicomponent fiber were heated at a desired temperature for 10 minutes and compressed at a desired pressure for 10 minutes. The mat was then cooled under similar pressure to a temperature of 40-45° C. The airlaid mat preforms were impregnated with different resins, Fire retardant Resin KRF 2000 (Resin A), and Regular polyester resin RL2701 (Resin B) using an infusion process.

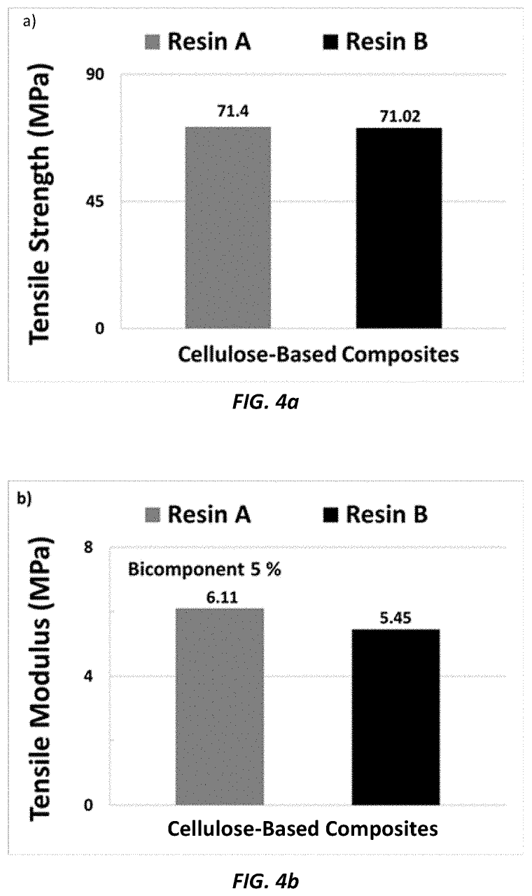

Tensile strength and tensile modulus measurements were acquired for each composite, as shown in FIG. 4a-4b. Tensile strength was measured according to ASTM D638-14 (2014) and tensile modulus was measured according to ASTM D638-14 (2014) as shown in Table 3 below.

### Results

FIG. 4a-4b show a graphical representation (4a) comparing the tensile strength and (4b) tensile modulus of reinforced composites wherein the resin type is varied.

TABLE 3

| | | Tensile Strength | Tensile Modulus |
|---|---|---|---|
| Composite | Resin | (MPa) | (GPa) |
| H | A | 71.4 | 6.11 |
| I | B | 71.02 | 5.45 |

As illustrated above, composites H and I can exhibit a tensile strength and/or modulus exceeding the required tensile strength and modulus for mass transit, car interior and/or building applications. FIG. 4a-4b illustrate the impact of compressed airlaid mat preforms as reinforcement on the mechanical properties of the resulting reinforced composite independently of the resin used. The composites exhibited a wood pulp fiber volume fraction of about 54%.

### Example 4

### Methods

Wood pulp fiber (SBSK pulp) and bicomponent fibers (TREVIRA, 6 mm, 1.3 dtex, PET core and PE sheath) were obtained and used to form an airlaid mat using conventional airlaid processes. Airlaid mat preforms made of 95 wt % wood pulp fiber and 5 wt % bicomponent fiber were heated at a desired temperature of 165° C. for 10 minutes. The mats were then compressed to the desired pressure and held at that pressure and temperature (165° C.) for 10 minutes. The mats were then cooled under similar pressure to a temperature of 40-45° C. A thin layer of fire retardant gel coat was applied using a drawdown process on the 2D mold prior to the airlaid mat preforms incorporation to the mold and impregnation with Fire Retardant Resin KRF 2000 (Resin A) by an infusion process.

Optical smoke density in flaming mode and non-flaming mode were measured according to ASTM E662-17a (2017), surface flammability using a radiant heat was measured according to ASTM E162-16 (2016), and flammability of interior materials was measured according to FMVSS 302 (37 C.F.R. § 571.302 (1998)). These respective measurements are shown in Table 4 below.

TABLE 4

| | ASTM E662-17a | | ASTM E62-16 | |
|---|---|---|---|---|
| | Optical Smoke Density | | Iₛ Surface | |
| | | Dₛ | Flammability | |
| | Dₛ | in Non- | of Materials | FMVSS 302 |
| | in flaming | Flaming | Using a | Flammability |
| | mode | Mode | Radiant Heat | of Interior |
| | 1.5 min | 1.5 min | Energy Source | Materials |
| Air-laid Rein- | 52 | 8.2 | 16 | Self- |
| forced Com- | | | | extinguishing |
| posite with | | | | |
| Fire Retar- | | | | |
| dant Resin | | | | |
| and Gelcoat | | | | |

As illustrated above, airlaid reinforced composites have shown an excellent performance through these tests meeting the fire-retardant requirements for mass transit applications.

### Example 5

Three samples were prepared and compared. The first sample was prepared in one temperature/pressure cycle. The second and third samples were prepared in two temperature/pressure cycles. The tensile strength and flexural strength of all three samples were compared and shown to be comparable.

Methods

Sample 1: Wood pulp fiber (SBSK pulp) and bicomponent fibers (TREVIRA, 6 mm, 1.3 dtex, PET core and PE sheath) were obtained and used to form an airlaid mat using conventional airlaid processes. Airlaid mat preforms made of 80 wt % wood pulp fiber and 20 wt % bicomponent fiber were heated at a desired temperature for 10 minutes and compressed at a desired pressure of 878 psi for 10 minutes. The mat was then cooled under similar pressure to a temperature of 40-45° C. The airlaid mat preforms were impregnated with a polyester resin (POLYNT RL-2710) using an infusion process.

Sample 2: Wood pulp fiber (SBSK pulp) and bicomponent fibers (TREVIRA, 6 mm, 1.3 dtex, PET core and PE sheath) were obtained and used to form an airlaid mat using conventional airlaid processes. Airlaid mat preforms made of 80 wt % wood pulp fiber and 20 wt % bicomponent fiber were heated at a first desired temperature for 10 minutes and compressed at a first desired pressure of 878 psi for 10 minutes. The mat was then cooled under similar pressure to a temperature of 40-45° C. The airlaid mat preforms were then heated to a second desired temperature for 10 minutes and compressed at a second desired vacuum pressure of 14.7 psi for 10 minutes. The mat was then cooled under similar pressure to a temperature of 40-45° C. The airlaid mat preforms were impregnated with a polyester resin (POLYNT RL-2710) using an infusion process.

Sample 3: Wood pulp fiber (SBSK pulp) and bicomponent fibers (TREVIRA, 6 mm, 1.3 dtex, PET core and PE sheath) were obtained and used to form an airlaid mat using conventional airlaid processes. Airlaid mat preforms made of 80 wt % wood pulp fiber and 20 wt % bicomponent fiber were heated at a first desired temperature for 10 minutes and compressed at a first desired pressure of 878 psi for 10 minutes. The mat was then cooled under similar pressure to a temperature of 40-45° C. The airlaid mat preforms were then heated to a second desired temperature for 10 minutes and compressed at a second desired pressure of 50 psi for 10 minutes. The mat was then cooled under similar pressure to a temperature of 40-45° C. The airlaid mat preforms were impregnated with a polyester resin using an infusion process.

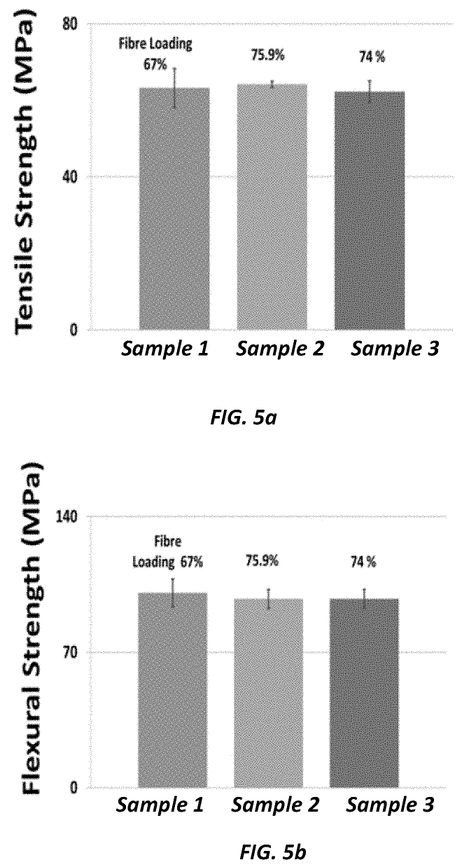

Tensile strength and flexural strength measurements were acquired for each composite, as shown in FIG. 5a-5b. Tensile strength was measured according to ASTM D638-14 (2014) and flexural strength was measured according to ASTM D790-17 (2017) as shown in Table 5 below.

### Results

FIG. 5a-5b show a graphical representation (5a) comparing the tensile strength and (5b) flexural strength of reinforced composites wherein the process for making the reinforced composites was varied.

TABLE 5

| | Total Fiber Loading | Tensile Strength | Flexural Strength |
|---|---|---|---|
| Composite | (wt %) | (MPa) | (MPa) |
| Sample 1 | 74 | 63.2 | 100.6 |
| Sample 2 | 67 | 64.1 | 97.4 |
| Sample 3 | 76 | 62.3 | 97.6 |

What is claimed is:

1. A method comprising:
forming a preform, comprising:
heating an airlaid mat to a temperature of from 40° C. to 200° C., the airlaid mat comprising a natural fiber component and a binder fiber component; and
compressing the airlaid mat at a pressure of from 100 psi to 1200 psi; and
impregnating the preform with a resin to form a reinforced composite having a natural fiber volume fraction of 20 vol % to 80 vol %, by volume of the reinforced composite.

2. The method of claim 1, further comprising cooling the airlaid mat to 40° C. after or during the compressing.

3. The method of claim 1, wherein the reinforced composite comprises a natural fiber volume fraction of from 26 wt % to 54 wt %, by volume of the reinforced composite.

4. The method of claim 1, wherein the preform comprises:
from 30 wt % to 99 wt % of the natural fiber component, by weight of the preform; and
from 1 wt % to 70 wt % of the binder fiber component, by weight of the preform.

5. The method of claim 1, further comprising heating the airlaid mat for 1 minute or less before compressing the airlaid mat.

6. The method of claim 1, wherein the forming a preform further comprises:
heating an airlaid mat to a first temperature;
compressing the airlaid mat at a first pressure for a first amount of time;
cooling the airlaid mat to a temperature of 40° C. to 45° C.;
heating airlaid mat to a second temperature;
compressing the airlaid mat at a second pressure for a second amount of time; and
cooling the airlaid mat to a temperature of 40° C. to 45° C.

7. The method of claim 6, wherein the first and second pressure are each independently from 100 psi to 1200 psi.

8. The method of claim 6, wherein the second pressure is lower than first pressure and is from 0 psi to 300 psi.

9. The method of claim 1, wherein impregnating the preform with a resin further comprises molding the preform.

10. A reinforced composite comprising:
an airlaid mat comprising a natural fiber component; and
a resin dispersed within the airlaid mat;
wherein the reinforced composite has a natural fiber volume fraction of 20 vol % to 80 vol %, by volume of the reinforced composite.

11. The reinforced composite of claim 10, wherein the airlaid mat further comprises a binder fiber component.

12. The reinforced composite of claim 11, wherein the airlaid mat comprises:
from 1 wt % to 70 wt % of the binder fiber component, by weight of the airlaid mat; and
from 30 wt % to 99 wt % of the natural fiber component, by weight of the airlaid mat.

13. The reinforced composite of claim 10, wherein the natural fiber component comprises at least one of a chemical pulp and a mechanical pulp.

14. The reinforced composite of claim 10, wherein the resin comprises an unsaturated polyester resin, an epoxy resin, a phenolic resin, or a combination thereof.

15. The reinforced composite of claim 10, wherein the resin comprises a flame-retardant resin.

16. The reinforced composite of claim 10, wherein the natural fiber volume fraction is from 35 vol % to 60 vol %, by volume of the airlaid mat.

17. The reinforced composite of claim 11, wherein the binder fiber component comprises a bicomponent fiber, the bicomponent fiber comprising:
a core polymer; and
a sheath polymer.

18. A reinforced composite comprising:
a fiber reinforcing material comprising 1 wt % to 70 wt % of a binder fiber component and 30 wt % to 99 wt % of a cellulose fiber component; and
a matrix comprising a resin;
wherein the reinforced composite has a cellulose fiber volume fraction of from 20 vol % to 80 vol %, by volume of the reinforced composite.

19. The reinforced composite comprising of claim 18, wherein the fiber reinforcing material comprises:
5 wt % binder fiber component, by weight of the fiber reinforcing material; and
95 wt % cellulose fiber component, by weight of the fiber reinforcing material;
wherein the resin comprises a polyester resin and the binder fiber component comprises a bicomponent fiber.

20. The reinforced composite of claim 18, wherein the cellulose fiber volume fraction is from 35 vol % to 60 vol %, by volume of the reinforced composite.
